(19) United States
(12) Patent Application Publication
(10) Pub. No.: US 2004/0105503 A1
(43) Pub. Date: Jun. 3, 2004

(54) Local communication system and apparatus for use therein

(76) Inventor: Hosein Mohamadzade, Surrey (GB)

Correspondence Address: Robert E Krebs, Thelen Reid & Priest, PO Box 640640, San Jose, CA, 95164-0640, US

(21) Appl. No.: 10/467,604

(22) PCT Filed: Feb. 6, 2002
(86) PCT No.: PCT/GB02/00482

(30) Foreign Application Priority Data
Feb. 6, 2001 (GB) 0102923.0

(51) Int. Cl. H04B 3/00; H04L 25/00

(52) U.S. Cl. 375/257

(57) ABSTRACT

An apparatus is disclosed for use as a first station in a network for transmitting and receiving digital data signals. The apparatus comprises a physical layer interface (PLC) for using twisted pair cable in place of optical fibre. The interface comprises a phase shift keying (PSK) encoder (310) and decoder (306) for transmitting and receiving data (TXD/RXD) to and from at least one other station each station including a similar encoder and decoder. The encoder comprises: means for receiving said digital data in the form of an encoded serial data signal together with at least one binary clock signal, the clock signal frequency being a small integer multiple of the data rate; means (402) for synchronising said digital serial data and said binary clock signal such that transitions in the one are aligned with transitions in the other; an encoding logic circuit (404) responsive to said digital serial data signal for selectively outputting one of said binary and the inverse thereof dependent on said serial data signal, so as to generate a PSK encoded binary waveform (Z); and driver means (406-416) for smoothing said encoded binary waveform and imposing the smoothed waveform (Z′) on said conductors in the form of an analogue differential signal pair (TX/nTX). The decoder comprises a differential integrator circuit (504+/504−), to decode such a PSK waveform so as to recover the digital serial data waveform. Various slew rates and decoder time constants are adjustable to suit different data rates. Decoder and encoder can operate synchronised but at different data rates.

### INTRODUCTION

The invention relates to a local communication system for digital serial data and various apparatus for use as transmitting and/or stations of such a network. The invention has many applications but is particularly intended to provide a low cost network for the integrated distribution of digital audio signals or other, high-volume “source data”, together with control messages, in vehicles.

A local communication system which combines source data (CD audio, MPEG video, telephone audio, navigation data etc.) with control commands in a low cost optical fibre network is available in the form of the D2B Optical system. For details, see for example the “Conan Technology Brochure” and the “Conan IC Data Sheet” available from Communication & Control Electronics Limited, 2 Occam Court, Occam Road, The Surrey Research Park, Guildford, Surrey, GU2 7YQ. United Kingdom (http://www.candc.co.uk). “Conan” is a registered trade mark of Communication & Control Electronics Limited. “D2B” is a registered trade mark of Philips Electronics NV.

The gross data rate in the D2B Optical system is 5.64 megabits per second (Mbps) (for an audio sampling rate of 44.1 kHz). Each segment of the network can carry 4.2 Mbps “source data” (for example three “CD quality” stereo audio channels of 1.4 Mbps each), together with control messages at a gross rate of about 176 kbps. Inventions disclosed in WO-A-98/36533 enable expansion of the capacity of such a network, for use in vehicles and the like. Frame formats and protocols are disclosed which significantly increase the data rate for such systems, The network interface disclosed therein is suitable for operation at different speeds, to maintain compatibility with existing D2B Optical Products and designs. The interface even enables a ring network to operate with the data rate in a first segment of the ring being higher than that in a second segment of the ring. Synchronisation is maintained in that example by the provision of a regular frame structure which has the same frame period in both segments of the network, but a larger quantity of data in each frame of the first segment.

The present invention has been developed to extend further the design freedom in implementing such systems, but is not limited in its application to the specific protocols or topologies of D2B Optical and compatible systems.

Although low cost fibre and electro-optical components can be used in the D2B Optical system, nevertheless the cost of these is a significant part of the cost of the network, and the range of commercially viable applications could in principle be widened by adopting, for example, a simple wire cable, such as unshielded twisted pair (UTP). This requires, however, that problems of susceptibility to and generation of spurious electromagnetic radiation and noise signals (EMI) should be eliminated. Not only is the automotive environment electrically very noisy, but also sensitive FM radio receivers and the like included in car audio systems are highly susceptible to interference from digital circuitry and its cabling.

It is noted that another proposal for an in-car network is CARNET, using a chip COM20023 available from Standard Microsystems Corporation, Hauppauge, N.Y. (see http://www.smc.com). CARNET uses ARCNET network protocols (ANSI Standard 878.1), with additional frequency shift keyed (FSK) encoding, which may be intended to permit wired networks with low EMI noise emission. The data rate with FSK is 5 Mbps, comparable to D2B Optical.

However, the CARNET chip generates the FSK waveform by digital synthesis, imposing high frequency quantisation noise on the desired band-limited signal. In practice, this noise includes components in the FM radio frequency band (87-108 MHz). In order to decode the received data correctly, the receiver of such signals must be provided with a clock signal whose frequency and phase are synchronised with the original transmitter clock. In the clock recovery circuit in the known D2B Optical network transceiver, mentioned above, this function is performed by the use of digital counter circuits which oversample the received waveform by a factor of ten or more.

Similarly, a known method of decoding a Manchester coded signal is discussed by Lester Sanders in an article “For Data-Comm Links, Manchester Chip Could Be Best”, Electronic Design Vol. 30, pp201-212, August 1982. This describes a two-part approach to synchronisation, using a synchroniser operating at twelve times the clock frequency detecting signal edges and a synchronisation-pulse detector which recognises specific patterns of data. Again, the counters and over sampling militate against a compact, low noise, low cost implementation.

FSK can be regarded as a binary version of frequency modulation (see J Dunlop and D G Smith, “Telecommunications Engineering” (Second Edition), Chapman and Hall, 1989, ISBN 0-412381907). Two carrier waveforms of different frequencies are defined and switched between, depending on the data bit values. A further form of modulation offering a more confined spectrum than FSK is phase shift keying (PSK), known and used in modems for lower-rate data communications via voice channels. In PSK different phase components at a single carrier frequency are selectively switched between, depending on the data to be transmitted.

WO-A-99/11024 discloses an alternative form of network based on analogue PSK modulation circuitry, and novel circuits for transmitting and receiving digital data by PSK modulation, as defined in the appended claims. The invention provides in effect a very simple high frequency modem, having very low noise emissions, compared with comparable known designs. It is also proposed in that document that the PSK encoding and decoding can be implemented by a small adaptor circuit connected between a digital communication interface (for example the CONAN IC) and its timing crystal. Such an interface might for example be a Conan IC implementing D2B Optical protocols, an ARCNET interface, or some other interface. A PSK demodulator forming part of the high frequency modem comprises a simple integrator circuit (low pass filter), followed for example by a comparator. The analogue circuitry proposed in that document can be difficult to implement in a digital or mixed-signal CMOS process, particularly where portability of the design between processes is desired, and where different data rates or other different modes are to be accommodated as in WO-A-98/36533, mentioned above.

It is an object of the invention in its various, independent aspects to provide an improved physical layer interface suitable for carrying high-bandwidth digital data via UTP twisted pair and similar media. In particular, the invention aims to retain the benefits of the systems mentioned above, while mitigating one or more of the problems identified above. Embodiments of the invention aim to combine one or more of the following attributes: low emissions of and susceptibility to EM noise; low power consumption ready integration with standard digital/mixed CMOS processes; high data rate capacity; ability to operate over a wide range of data rates; ability to interface between segments of a synchronous ring network operating at different data rates and at distances up to 20 metres or so.

In a first aspect, the invention provides an apparatus for use as a first station in a local communication system for transmitting a digital data signal, for example a signal of at least 1.4 Mbps gross data rate, the apparatus comprising a phase shift keying (PSK) encoder and decoder for transmitting data to and from at least one other station via electrical conductors, each station including a similar encoder and decoder, the encoder comprising:

means for receiving said digital data in the form of an encoded serial data signal together with at least one binary clock signal, the clock signal frequency being a small integer multiple of the data rate within the encoded serial data signal such that an integral number of cycles of the clock signal occur between transitions of the encoded serial data signal;

means for synchronising said digital serial data and said binary clock signal such that transitions in the one are aligned with transitions in the other;

an encoding logic circuit responsive to said digital serial data signal for selectively outputting one of said binary and the inverse thereof dependent on said serial data signal, so as to generate a PSK encoded binary waveform; and

driver means for smoothing said encoded binary waveform and imposing the smoothed waveform on said conductors in the form of an analogue differential signal pair,

the decoder of the apparatus being adapted to decode said PSK waveform so as to recover the digital serial data waveform.

The clock signal frequency may be regarded as the PSK carrier frequency, and may be twice the highest frequency component contained within said encoded serial data signal, for example.

The encoding of said digital serial data signal and the clock frequency may be selected such that said integral number takes the value one or two, depending on the data content of the data signal, and disregarding any special synchronisation patterns present in the data signal. Such an embodiment is suitable for biphase and similarly encoded waveforms, where essentially pulses have one of two widths. The integral number may take a wider range of values, for example in 4B/5B or 8B/9B coding, where longer run lengths are present in the encoded serial data signal.

The encoding logic circuit may comprise an exclusive-OR gate. By analogy with the encoder of WO-A-99/11024, the exclusive-OR (XOR) function may be viewed as an inverter for generating an inverted version of the clock signal, and a multiplexer for selecting between the inverted and non-inverted versions of the clock signal. In the digital domain, this function is equivalent to an XOR function.

Said serial data signal maybe channel encoded so as to comprise either one or two transitions per data bit. Said serial data signals may be encoded in differential form such that the recovered serial data signal is independent of inversion of the PSK encoded signal.

The synchronising means may be combined with the generation of the encoded serial data signal. The encoder may also comprise an encoder for generating said encoded digital serial data signal from a non-encoded data signal. Alternatively, particularly where the encoder is located on a different integrated circuit from the source of the digital serial data signal, the synchronising means may be a distinct circuit.

The carrier frequency of said PSK waveform may be twice the gross data bit rate of said serial data signal. The carrier frequency may be 5 MHz or more, while the carrier frequency may be 10 MHz or more.

The apparatus may be adapted for use where said electrical conductors comprise a twisted pair cable, said driver means comprises a differential line driver, and said demodulator includes a differential input circuit for rejection of common mode noise.

The driver means may include means for reproducing said encoded binary waveform with a slew rate regulated such that the reproduced waveform is substantially trapezoidal. Each transition may for example occupy a significant portion of the clock period. In this way, high frequency components of the waveform are greatly reduced. The transitions may for example occupy more than 30 percent, preferably more than 60 percent of the minimum period between transitions (the actual period between any pair of transitions depends on the data content). On the other hand, a triangular waveform is also to be avoided, and the transitions, defined for example by time when the signal lies between 10% and 90% of the peak-peak amplitude, may occupy less than 90%, or less than 80% of the minimum nominal period between transitions. Alternative definitions of the slew time are of course possible, and one alternative is provided below, in the detailed description of the embodiments.

The encoder may include means for adjusting said slew rate in proportion with the rate of data being transmitted.

Where the encoder is part of an integrated circuit, the adjustment means may include a connection for an external resistor. The same resistor may control other frequency-dependent parts of the integrated circuit, including for example: a VCO centre frequency as part of a phase-locked loop; a time constant within the decoder.

The adjustment means may alternatively, or in addition, be controlled by a digital signal. Frequency-dependent parts of the encoder and decoder may be controlled separately, so as to permit different data rates at the receiver and encoder.

The means for adjusting the slew rate may comprise at least one constant current source arranged to feed a capacitor under control of the PSK binary waveform, the current source current being adjusted according to the data rate.

The encoder may further comprise a filter circuit for removing frequency components higher than the PSK carrier frequency, prior to imposing the encoded signal onto said conductors. The filter may be of three or more poles, for example comprising a 5^{th} or 7^{th} order filter. The filter may be implemented externally of an integrated circuit on which the remainder of the encoder is located.

In a second aspect, the invention provides a non-coherent PSK decoder comprising an integrator circuit for integrating a received PSK encoded signal and a threshold comparator for converting the integrated signal into a digital data signal, the decoder including means for adapting the decoder to different PSK carrier frequencies by adjusting at least one of the integrator time constant and the comparator threshold.

Where the decoder is part of an integrated circuit, the adjustment means may include a connection for an external resistor. The same resistor may control other frequency-dependent parts of the integrated circuit, including for example: a VCO centre frequency as part of a phase-locked loop; an edge slope as part of an encoder for onward transmission of data.

The integrator may comprises at least one constant current source arranged to feed a capacitor under control of the received PSK signal, the current source current being adjusted according to the expected PSK carrier frequency.

In a third aspect, the invention provides a non-coherent PSK demodulator comprising an integrator circuit for integrating a received PSK encoded signal and a threshold comparator for converting the integrated signal into a digital data signal, the PSK demodulator comprising a comparator for converting the received PSK signal to a series of binary pulses prior to said integrator circuit, the integrator circuit and threshold comparator thus acting as a pulse width discriminator.

In a fourth aspect, the invention provides a non-coherent PSK demodulator comprising an integrator circuit for integrating a received PSK encoded signal and a threshold comparator for converting the integrated signal into a digital data signal, the integrator circuit comprising a separate integrator and threshold comparator for positive- and negative-going parts of the received PSK waveform, and a logic circuit or combining the outputs of the comparators to generate a decoded data signal.

In a fifth aspect, which may be used to implement the apparatus of the first aspect set forth above, the invention provides a physical layer interface for use in a local communication system (particularly one for transmitting a digital data of at least 1.4 Mbps gross data rate), the physical layer interface comprising:

means for receiving said digital data in the form of an encoded serial data signal;

driver means for smoothing said encoded binary waveform and imposing the smoothed waveform on said conductors in the form of an analogue differential signal pair, decoder means adapted to receive and process a similar differential signal pair so as to recover a digital serial data waveform from another station in the network.

The driver means may include means for reproducing said encoded binary waveform with a slew rate regulated such that the reproduced waveform is substantially trapezoidal. Each transition may for example occupy a significant portion of the minimum period between transitions. In this way, high frequency components of the waveform are greatly reduced. The transitions may for example occupy more than 30 percent, preferably more than 60 percent of the clock period. On the other hand, a triangular wave form is also to be avoided, and the transitions, defined for example by time when the signal lies between 10% and 90% of the peak-peak amplitude, may occupy less than 90%, or less than 80% of the minimum period between transitions.

The driver means may include means for adjusting said slew rate in proportion with the rate of data being transmitted.

Where the driver means is part of an integrated circuit, the adjustment means may include a connection for an external resistor. The same resistor may control other frequency-dependent parts of the integrated circuit, including for example: a VCO centre frequency as part of a phase-locked loop; a time constant within the decoder.

The adjustment means may alternatively or in addition be controlled by a digital signal. Frequency-dependent parts of the driver and decoder may be controlled separately, so as to permit different data rates at the driver and decoder.

The means for adjusting the slew rate may comprise at least one constant current source arranged to feed a capacitor under control of the PSK binary waveform, the current source current being adjusted according to the data rate.

The apparatus may be adapted for use where said electrical conductors comprise a twisted pair cable, said driver means comprises a differential line driver, and said decoder includes a differential input circuit for rejection of common mode noise.

The physical layer interface circuit may further comprise a filter circuit for removing frequency components higher than the PSK carrier frequency, prior to imposing the encoded signal onto said conductors. The filter may be of three or more poles. The filter may be implemented externally of an integrated circuit on which the remainder of the interface is located.

The various aspects of the invention as set forth above are independent, but may be used in combination. These and other variations and modifications of the invention may be envisaged by the skilled reader, from the above introduction and from consideration of the detailed examples which follow.

### BRIEF DESCRIPTION OF THE DRAWINGS

Embodiments of the invention will now be described, by way of example only, with reference to the accompanying drawings, in which:

FIG. 1 shows a ring network including various stations communicating over a ring network in an automotive audio/video and communication system embodying the present invention;

FIG. 2 illustrates in more detail the interfacing of two of the stations of FIG. 1 network to the ring, via physical layer controller (PLC) ICs;

FIG. 3 shows in block schematic form the internal structure of one PLC, including detail of a phase-locked loop (PLL);

FIG. 4 shows in more detail a PSK encoder and driver section of the PLC;

FIG. 5 shows in more detail a PSK decoder section of the PLC;

FIG. 6 shows waveforms present in the encoding and decoding of PSK signals in the circuits of FIGS. 3 to 5;

FIGS. 7 and 8 illustrate two different applications, including configuration of PLC ICs, according to the desired operating modes of the network stations; and

FIG. 9 illustrates a further application, in which a synchronous ring network includes segments and stations operating at different data rates using the various modes of the novel PLC device.

### DETAILED DESCRIPTION OF THE EMBODIMENTS

Background

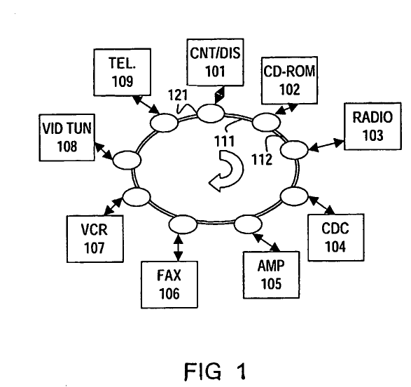

The automotive (in-car) A/V system illustrated in FIG. 1 comprises nine audio- or video-related apparatuses 101-109 connected as stations (or nodes) of a Local Area Network (LAN). Of course more or fewer than nine stations may be accommodated. In this example system, the apparatuses are: a control and display unit 101, a Compact Disc memory (CD-ROM) reader 102, a radio turner 103, a CD changer unit 104, an audio power amplifier 105, a facsimile send/receiver unit (FAX) 106, a video recording system (VCR/CAMCORDER) 107, a video tuner 108, and a telephone 109. The display function of the control and display unit 101 may for example provide for display of information read from memory devices by CD-ROM and/or display of video signals from tuner 108 or VCR 107.

The LAN interconnection in the known system comprises nine unidirectional point-to-point links 111, 112 etc. linking interface modules 121 etc., each of which is substantially structurally identical, such that the nodes are all connected in a ring. In the known D2B Optical system, as its name implies, each link 111 etc. comprises a fibre optic link carrying a combination of digital audio/video signals, CD-ROM data and control messages in accordance with a predetermined signal frame structure. Various frame formats, including the well-known SPDIF (also known as AES-EBU or IEC 958). D2B Optical (“single speed”), double speed and high speed formats may also be carried, as described in WO-A-98/36533 mentioned above. A designated station (referred to hereinafter as the system master), such as the control/display unit 101, continuously generates the frame structure at a frame sample rate of 20-50 kHz (typically 44.1 kHz as for CD sampling). One station on the network is designated to act as system master on power-up although the role of system master may subsequently be re-allocated to another station, for example in fault conditions.

The implementation of a station's interface follows the layered approach commonly referred to in any network system. At the highest level, source data management (audio/video etc.) and control application layers operate to provide the functionality which users desire from the system. Within each station, a network interface controller (NIC) such as the CONAN®chip provides or at least supports the controller in providing communication management, network management and media access control (MAC) functions related specifically to communication via the network. These functions are described in greater detail in WO-A-98/36533 mentioned above. The present application concerns primarily the physical layer interface, with particular reference to unshielded twisted pair (UTP) media, and features of clock recovery applicable on other physical layers.

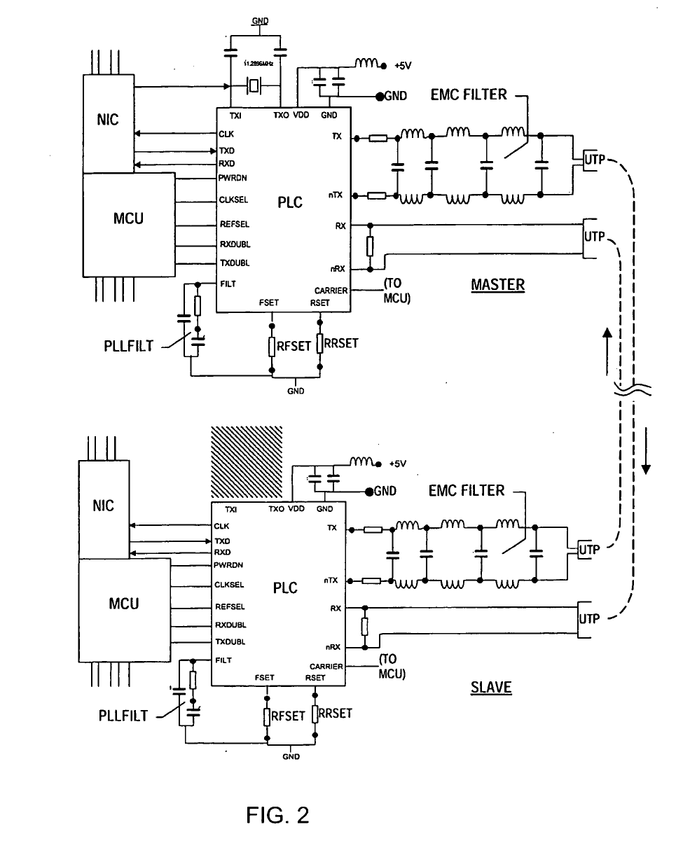

FIG. 2 illustrates in more detail two of the stations communicating via the UTP network in the system of FIG. 1. In the top half of the diagram, a master station is represented, while a representative slave station is represented in the lower half of the drawing. The UTP connections are shown in broken lines at the right hand side of the diagram, it being understood that a number of other slave stations may be interposed upstream and or downstream of the slave shown in the diagram.

FIG. 2 shows principally those components concerned directly with the network communication, and it will be understood that other components, whether they be computers, radio tuners, loud speakers or whatever, will be provided in accordance with the principal function of each station.

Within the master station, communication via the network, and possibly other functions within the apparatus, are controlled primarily by a microcontroller MCU. The burden of network communications is primarily taken by a network interface controller circuit NIC, as mentioned above. Between the NIC and the UTP connections of the network itself, a novel physical layer controller PLC is provided. In the present embodiment, the MCU, NIC and PLC comprise separate integrated circuits. In practice, two or three of these units may be integrated on a single chip, optionally with further functional elements such as digital audio circuitry. One of the benefits of the PLC as a separate device, however, is that it provides an adapter between a UTP physical layer and NIC devices of various types, whose output is not specific to any particular physical layer.

Between the MCU and the PLC, various control lines PWRDN, CLKSEL, REFSEL, RXDUBL, TXDUBL and CARRIER are provided, whose functions are explained briefly in Table 1 below, and further in the more detailed description of the PLC and its operation. Between the NIC and the PLC, connections TXI, CLK, TXD and RXD carry the clock and serial data signals to be transmitted on and received from the network. A crystal or other resonant element is connected between pins TXI and TXO of the PLC.

Network driving pins TX and nTX are connected to the outbound portion of the UTP network via an EMC filter arrangement. This filter is designed particularly to suppress harmonics of the PSK carrier frequency which would fall within the FM radio band (or vice versa), which is important in in-car audio applications. This filter is strictly optional, and either no filter or filters specific to other applications may be provided. The form of filter shown can for example be adapted to improve common-mode noise suppression, by replacing each capacitor by a series pair, with the central node of each pair connected to ground (the value of each capacitor in the pair should be double the original value, in that case).

Connections RX and nRX are connected to the inbound segment of the UTP network for receipt of PSK encoded data.

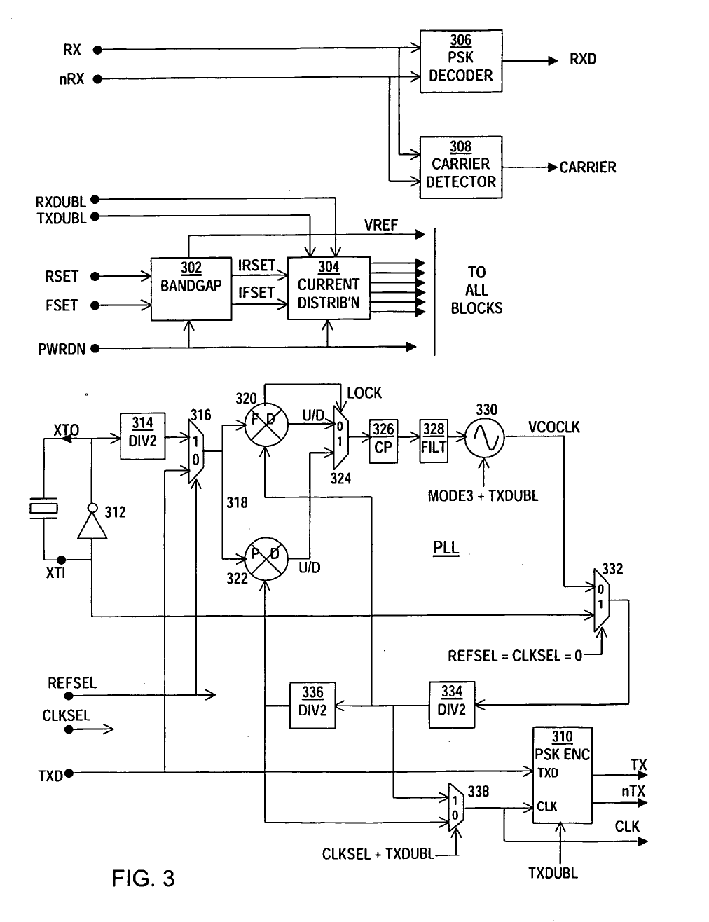

Two resistors RFSET and RRSET are connected between respective pins of the PLC and ground, to configure the device as explained below. Finally, external filter components PLLFILT are connected to pin FILT, to define filtering characteristics of the phase-locked loop (PLL) described in more detail below, with reference to FIG. 3.

In the slave station, it will be seen that the configuration is essentially identical. However, a hatched box highlights the absence of the crystal, and the connection TXI between the NIC and the PLC. As discussed above, in the slave station, the data and clock of the NIC is synchronised with that of the master station, and no independent crystal oscillator is required. On the other hand, these components may be provided for use under fault conditions, in which case a slave station may temporarily be required to become master. Similarly, such components would be provided in any apparatus which was configurable to act as master or slave, in different applications. The various mode selecting lines between the MCU and the PLC determine whether the crystal is used as a reference, or whether the clock reference is to be recovered from the received work signal.

PLC Overview

The internal structure of the PLC is described below with reference to FIGS. 3 to 5. The function of each pin on the PLC integrated circuit is specified in the Table 1 below.

FIG. 3 shows the internal structure of the PLC IC used in the various network stations of FIGS. 1 and 2. Two blocks which serve all parts of the circuit are a bandgap voltage reference generator 302 and a current distribution block 304. The bandgap generator 302 uses known principles to provide a voltage reference signal VREF for use in other blocks of the PLC. Also, using this reference and the external resistors connected to pins FSET and RSET, the circuit 302 generates a reference current IRSET, and a frequency reference current IFSET, dependent on the frequency mode desired, in a manner described hereinafter. Current distribution block 304 replicates these currents in various ratios, for use throughout the remainder of the circuit. Block 304 also receives signals from the pins RXDUBL and TXDUBL, for varying the ratios for certain currents, in a manner dependent on the desired mode of operation. The internal structure of blocks 302 and 304 is not material to the present invention and will not be further described.

TABLE 1
PLC pinout

| Pin Name | Input/Output Type | Function |
|---|---|---|
| XTI | Analogue Input | Crystal and external Clock input |
| GND | Ground | Ground Connection |
| CLK | Digital CMOS Output | Clock Output |
| CLKSEL | Digital CMOS Input | PLL Clock Select input |
| PWRDN | Digital CMOS Input | Power down input |
| FILT | Analogue Input/Output | Charge Pump Filter Input/Output |
| REFSEL | Digital CMOS Input | PLL Reference clock select input |
| RXDUBL | Digital CMOS Input | Double Receive frequency input |
| TXDUBL | Digital CMOS Input | Double Transmit frequency input |
| FSET | Analogue Input | Carrier frequency setting resistor |
| | | input |
| RSET | Analogue Input | Current reference setting resistor |
| | | input |
| CARRIER | Digital CMOS Output | Carrier present output |
| RX | Analogue Input | Receiver differential input |
| nRX | Analogue Input | Receiver differential input |
| TXD | Digital CMOS Input | Transmit bi-phase data input |
| RXD | Digital CMOS Output | Receive bi-phase data output |
| NTX | Analogue Output | Transmit differential Output |
| TX | Analogue Output | Transmit differential Output |
| VDD | Power | Positive Power supply |
| XTO | Analogue Output | Crystal Ouput |

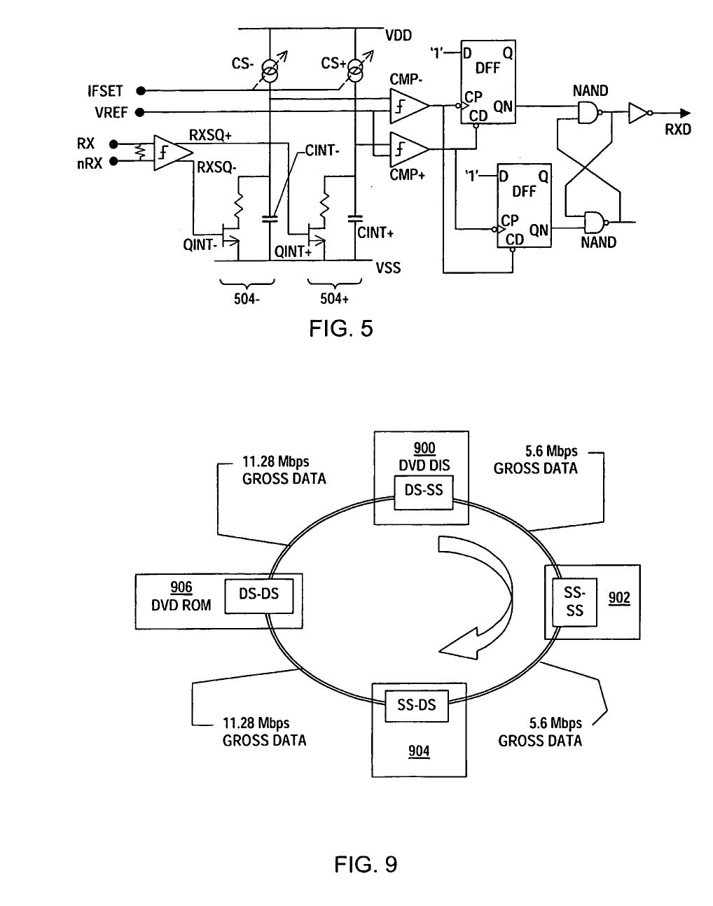

Pins RX and nRX are connected to a PSK decoder block 306, which outputs a received data bitstream RXD. The inputs are also provided to a carrier detector circuit 308, which indicates presence of carrier on the network via signal CARRIER. PSK decoder block 306 will be described below in more detail, with reference to FIG. 5. A power down control signal PWRDN is passed to all blocks, and reduces current consumption to a minimum, while the carrier detector 308 continues to function. The operation of this power saving arrangement will be described briefly below. This feature may be made the subject of a patent claim in due course.

Referring briefly to the power saving features in operation, the power down mode is entered when the PWRDN signal is set high. Note that this pin has an internal pull-up and if the function is not used then this pin must be connected to ground. When PWRDN is set high the whole of the chip enters a very low power mode of operation where only the wake-up circuitry is active. The internal modifications in each module which are responsive to the PWRDN signal are conventional power-saving measures, and will not be described in detail as they do not form part of the present invention. Typically, every current-carrying transistor will be gated off by an auxiliary transistor, responsive to the PWRDN signal. The TX and nTX signals are forced to ground as a means of indicating to the next chip on the network that it too should power-down.

Block 308 in each node monitors the RX/nRX pins to see if the input voltage is below a certain threshold (typically 0.5V), well below the normal operating voltage. The RX and nRX pins must be held in this state for a minimum of 10 uS before the circuit indicates loss of carrier (CARRIER set low). On a node resetting PWRDN, the chip comes out of the very low power mode of operation and begins transmission on TX and nTX. At the RX and nRX pins of the next chip in the network the presence of a carrier is detected and CARRIER is set high. The carrier must be present for a period of 10 uS minimum before the carrier is detected. Note that signal CARRIER does not have any fixed consequence within the PLC chip: the power saving behaviour is determined by the programmer of the external MCU, who determines freely whether, and under what conditions, the lack of a carrier signal should result in a power down or power-up action. This is controlled by the MCU via the separate input PWRDN.

Returning to the description of FIG. 3, at the bottom right a PSK encoder and driver block 310 is provided, which drives the network output pins TX and nTX as a differential pair. This is described in more detail below with reference to FIG. 5. The remainder of FIG. 3 shows in more detail the phase-locked loop (PLL) arrangement, which provides the clock reference for the PSK encoder 310.

External clock (crystal) input XTI is connected to an inverter 312 which drives the crystal, when present, and then passes via a divide-by-two circuit 314 to a first input of a multiplexer 316. The other input of multiplexer 316 is fed from the transmit data input TXD. Which input is fed to output 318 of multiplexer 316 is selected by the control signal REFSEL (from MCU in FIG. 2). REFSEL=0 selects TXD as the reference source, as appropriate to clock recovery mode. REFSEL=1 selects the divided signal from pin XTI, which could be from a crystal as shown, or an external clock input, appropriate to the situation within the master station. The reference signal at 318 is connected to the input of the frequency detector (FD) 320 and a phase detector (PD) 322, forming part of an assisted-acquisition phase frequency detector. Outputs of these devices comprise up and down logic signals U/D which are fed to inputs of a multiplexer 324. The multiplexer 324 is controlled by a “locked” signal LOCK from the frequency detector 320, so as to output the up and down signals generated by FD 320 initially, and then those generated by PD322 when a lock condition is signalled by the FD, as explained further below. The selected up/down signals are applied to a charge pump circuit 326. Using the PLL filter components PLLFILT (FIG. 2) a filter 328 is formed and driven by the charge pump of the PLC (FIG. 2), to generate a VCO control voltage.

A voltage controlled oscillator (VCO) 330 is provided, which responds to the control voltage output by filter 328, and also receives a control signal VCODUBL. VCO 330 has a centre frequency set on a continuous scale by the value of the external resistor of FSET, and can operate at the frequency or double this frequency, in accordance with the logic input VCODUBL. The VCO output is connected to a further multiplexer 332. A second input of the multiplexer 332 receives the external clock signal XTI. In a mode where REFSEL and CLKSEL are both 0, as set by the MCU in FIG. 2, the output of multiplexer 332 replicates the external clock signal on an XDI, and the output of VCO 330 is ignored.

Whichever clock signal is elected by multiplexer 332 divided by two in frequency at 224 and is supplied as a local oscillator signal to FD 320, for comparison with the selected timing reference at 318. The same signal is divided by two again at 336 for use as the local oscillor for PD 322. The signals generated by VCO 330 and provided as local oscillator signals to PD 322 and FD 320 include both in-phase and quadrature components (not shown separately in FIG. 3). A further multiplexer 338 receives both the output of the frequency divider 334 and the output of 336. The output of multiplexer 338, selected from between these two signals, is supplied to the PSK encoder as a clock signal CLK. The same clock signal PLK is output to the NIC to control the operation of the entire network interface. It will be understood the signal CLK is synchronise between all the stations of the network, and it forms the basis for the transmission of data, frame structure and so forth. Multiplexer 338 is controlled to select the output of multiplexer 334 rather than 336, in modes where either CLKSEL or TXDUBL is set at one logic one by the MCU.

The frequencies present on various lines are marked for illustrative purposes only, assuming a 22.56 megahertz crystal is connected between XTI and XTO lines as shown. It is also assumed for this purpose that the control signals REFSEL and CLKSEL are set by the MCU at one and zero respectively. Various modes of operation are possible, as will be explained further below, and the frequency of operation can be selected freely, according to the application. The frequencies of operation in the examples described herein are chosen to be related to the standard digital audio sampling rate of 44.1 kHz, for synchronise transfer of digital audio data.

The internal structure of the frequency detector FD 320 and phase detector PD 322 are not described in detail herein, but suitable forms of component are known to those skilled in the art, for example from Pottbacker, Langmann & Schreiber: “A Si Bipolar Phase and Frequency Detector IC for Clock Extraction up to 8 Gb/s”, published in the IEEE Journal of Solid-State Circuits, Vol. 27 No. 12 (December 1992), pages 1747 to 1751. Broadly speaking, The frequency detector FD 320 is formed by two dual-edge triggered D-type flip flops, clocked by the reference signal TXD at 318. At edge of TXD the flip-flops sample the clock and quadrature clock inputs, which are decoded via latches and gates to generate the up and down pulses. Frequency detector FD 320 also includes lock detection circuitry to provide the control signal LOCK to multiplexer 324. Phase detector PD 322 comprises a conventional XOR-type phase detector.

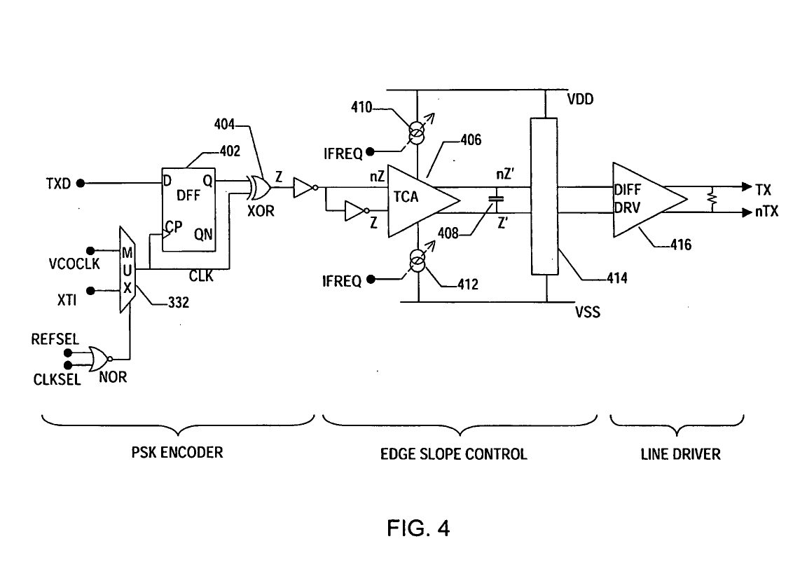

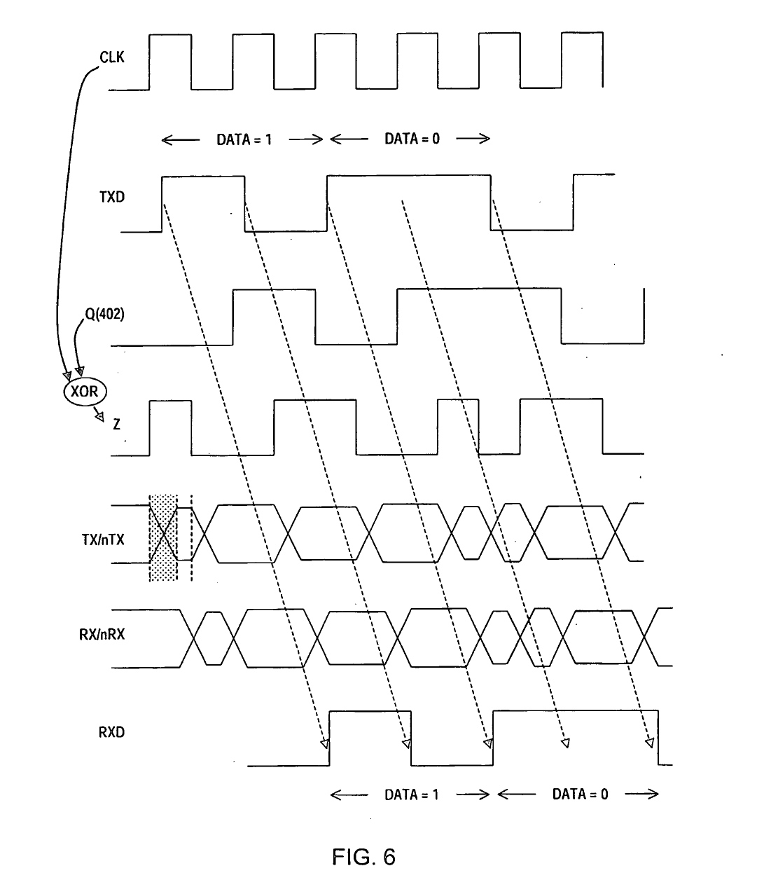

FIG. 4 shows in more detail the PSK encoder 310 of the PLC, while FIG. 5 shows the PSK decoder 306. FIG. 6 shows wave forms at various states in the encoding and decoding.

PSK Encoder 310

Referring first to the encoder FIG. 4, the data to be transmitted TXD is received on a D terminal of a D-type flip-flop 402 the clock input CP of FF 402 receives the appropriate clock signal CLK via multiplexer 332, under control of the signals REFSEL and CLKSEL. Dividers 334 and 336, and multiplexer 338 are omitted in FIG. 4, for simplicity. Representative signals CLK TXD are shown at the top of FIG. 6. The output Q is a re-synchronised version of signal TXD, such that transitions coincide more or less exactly with positive transitions in signal CLK. These two signals are then applied to XOR gate 404 to provide a “digital PSK” wave form Z.

The digital PSK wave form has sharp transitions, and is therefore unsuitable for transmission via the network in a low EMC application. An edge slope control section is therefore provided, centred around a differential transconductance amplifier 406. Inputs to TCA 406 are Z and its inverse nZ, which is a differential version of the digital PSK signal Z.

Output of TCA 406 are in the form of currents, connected to charge and discharge capacitor 408 at well-regulated rates. The output currents are regulated by variable current sources 410 and 412, which are controlled by a current IFREQ set by the current distribution circuit 304 based on the frequency-setting resistor RFSET (FIG. 2). The common mode (DC) level of the differential signal Z′/nZ′, which is thus formed across the capacitor 408, is set at a value somewhere between the supply voltages VSS and VDD, by a clamping arrangement 414. The differential voltage signal from capacitor 408 is then amplified by differential line driver 416 to emerge on pins TX and nTX, connected to the UTP network (FIG. 2). The resulting signals are shown in FIG. 6. It will be seen that TX/nTX reproduce the digital PSK signal Z in differential form, and also with markedly sloping transitions. The slope of transitions is directly regulated by the size of capacitor 408, and the magnitude of the charging controlled 410, 412 within the transconductance amplifier 406. By this means, irrespective of variations in the clock frequency, the resistor RFSET can be used to achieve a desired shape of output wave form, in which the sloping transitions occupy a substantial portion of the shortest cycle of time. The output wave form accordingly is closer to a sinewave than the digital PSK signal Z, and causes fewer EMC problems, having lower harmonics. As explained the reference to FIG. 2, additional filtering can be provided, either before or after the line driver according to the requirements of a given application.

A simple parallel resistor is shown for impedance matching. Of course, series and/or parallel resistances of different values may be appropriate, according to the need for matching the impedance of the line (UTP, co-axial etc), and the filter. For both accuracy and repeatability, it is preferred that these resistances be left external to the PLC IC.

The transition time is shown shaded at the first transition in FIG. 6 with the remainder of total time unshaded. Measuring, for example, between 10% and 90% of the peak-peak amplitude, the sloping transitions may for example occupy more than 30%, preferably more than 50% of the total pulse width, for the shortest pulses in the digital PSK waveform. On the other hand, if the slope is too shallow (too small) a triangular wave form will result, which loses amplitude at the receiver, and contains higher harmonics than the trapezoidal waveforms shown. The facility to tailor the slope and VCO frequency simultaneously using resistor RSET therefore allows acceptable noise performance across a very wide range of frequencies, by simple means. Defining the slew time alternatively as 1.1 times the rise time from 5% to 95% peak-peak, a preferred slew time is in the range 55-75% of the shortest nominal pulse width. Broader ranges of 50-85% can be envisaged, depending on the requirements of the application, the external filtering, the operating frequency and so on.

PSK Decoder 306

Referring now to FIG. 5 and the wave forms of FIG. 6, the PSK decoder receives a differential signal pair RS/nRX from the UTP network. As in application WO-A-99/11024, mentioned above, an integrator is used as a non-coherent PSK decoder, to reproduce the received data signal RXD in digital form. The integrator in the present example takes a different form, however, as will now be explained. As at the transmission side, different termination resistors may be required, according to the cable used, and these are preferably left external to the PLC IC.

The received differential signal RX/nRX is passed to the inverting and non-inverting inputs of a fast differential comparator 502, which generates a corresponding differential pair of digital (by EU square wave forms RSXQ+ and RSXQ−). Separate integrating arrangements 504+ and 504− are provided, to integrate the two halves of the differential signals. Each integrator comprises a switching transistor QINT, a current source CS controlled by the frequency setting current IFSET, and a capacitor CINT. When RSQ+ is high and RSQ− is low, capacitor CINT is charged up with a frequency-dependent bias current from source CS− at this time, the other capacitor CINT+ is discharged. The voltage on each capacitor is compared by a respective comparative CMP+ or CMP− with a voltage reference obtained from the bandgap preference generator 302 (FIG. 3). Each integrator/comparator arrangement forms a pulse with discriminator. If the width of the input pulse is larger than the preset value, determined by the current bias, capacitance CINT and the voltage reference, then, the output of the comparator will generate a pulse. As one capacitor is being charged, then the other capacitor is being discharged.

Alternate pulses obtained from the two comparators CMP+ and CMP− are routed to a logic circuit comprising a pair of flip flops (DFF) and logic gates, which reconstitute the signal RXD, as shown at the foot of 306. Comparing wave forms RX/nRX and RXD, it will be seen that a transition in RXD occurs only after a long pulse in the received wave form which corresponds to a phase reversal in the digital PSK signal Z. Since the effect of the PSK encoder is to cause a phase reversal at each transition in the wave form TXD, the wave form RXD is according a faithful reproduction of a wave form TXD, generated by the network interface controller (NIC) of the previous station on the UTP work.

Again, by reference to the signal resistor RFSET, the time constants of the integrating circuits, in other words the pulse width threshold implemented by the pulse width discriminator, can be set to be suitable for a particular operating frequency. The operation of the PLC in its various modes will now be explained in more detail, and with reference to particular examples.

PLC Modes of Operation

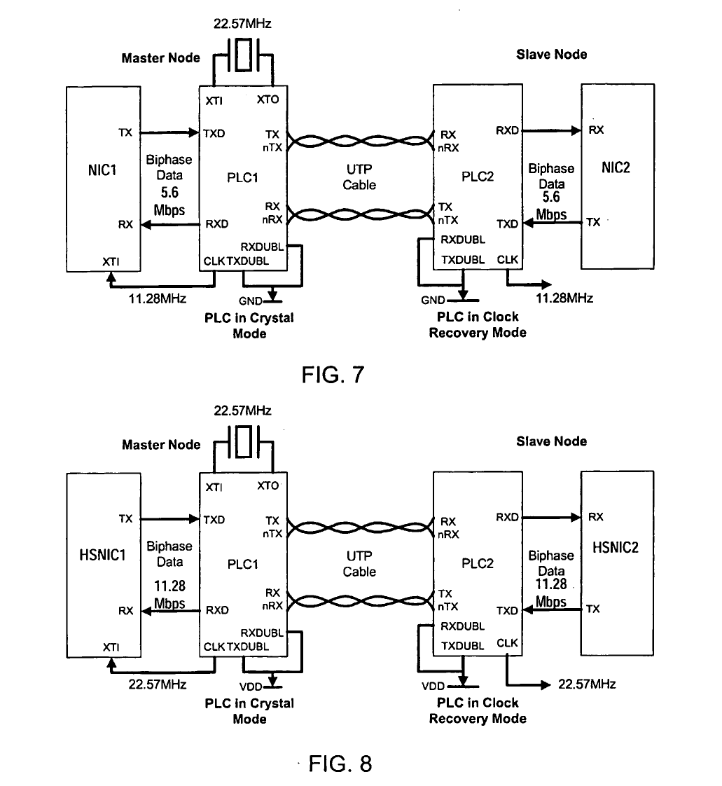

Examples of the different modes of operation will now be described, and can be understood with reference to stations 1 (Master) and 2 (Slave) in the examples of FIGS. 7 and 8. In these examples, data rates of 5.64 Mbps and 11.28 Mbps are assumed, by way of example only, being respectively 128 and 256 times the sample rate of CD digital audio (44.1 kHz). This is for the purpose of illustration only, and is not to be taken as a limitation of the scope of the invention.

Mode 1. External Clock: REFSEL=1, CLKSEL=1

This mode is not directly illustrated in FIG. 7 or 8, but is an alternative configuration of the Master node. In this mode a clock signal is supplied externally to the PLC at the XTI input, and is used by the PLL to lock and generate a synchronised clock signal CLK. This clock is then used by the PSK encoder 310 to generate TX/nTX output signals for driving the UTP cable. Mode 3 is preferred over Mode 1, to reduce jitter in the network signals.

The Lock range of PLL in this mode is almost 100% and Clock Out at pin CLK will be synchronous to the External Clock after an initial lock time.

If TXDUBL=Low (0) then for Bi-phase data at 5.64 MHz (5.64 Mbps) from the NIC, the External Clock signal should be at 11.28 MHz, and PLC will generate a locked Clock signal at CLK. This is the situation in FIG. 7 where the NICs are for example the original “single speed” CONAN network transceiver chips.

If TXDUBL=High (1) the PLC doubles the Data and Clock Frequency and the external Data and Clock runs at double speed. This is appropriate to the FIG. 8 situation, in which the NICs (now designated HSNIC1 and HSNIC2) have higher speed capability, such as the Super CONAN device.

For proper operation, the PLC is started from the power down mode and all the signal levels settled to valid state. In a situation when external Clock signal is lost the XTI pin could go to a low or high logic level causing the PLL to free run at low frequency which could be passed through the receiver, hence preventing lock at the NIC.

Mode 2. Clock Recovery: REFSEL=0. CLKSEL=1

This will be the configuration of the PLC2 in each of FIGS. 7 and 8. In this mode, the clock signal is recovered and generated from the incoming Bi-phase data on the TXD pin by means of the internal PLL. This signal CLK is synchronised with the input data and is passed to PSK Encoder 310 to generate TX/nTX output signals to drive UTP cable. It may also be used by application circuits outside the PLC and NIC, for example to synchronise a digital audio source with the network clock.

Note that synchronisation with data received from the master station is achieved via the existing network PLL within the NIC, rather than directly from the received data signal RXD. That is to say, the NIC such as a CONAN chip receives bi-phase data RXD from the previous station in the network, synchronises itself with the received data, and then output transmit data TXD also synchronised with the received data. The PLC synchronises its own clock and PSK carrier with the transmit data TXD, not directly with the received signal RXD. In this way, the entire ring network is synchronised without the adaptor (PLC) being designed specifically for the symbol and frame structures of the network signals being carried.

If the Bi-phase data rate is 5.64 MHz (5.64 Mbps) then PLC will generate a 11.28 MHz Clock in phase to the Master clock from the NIC. In this case TXDUBL of the PLC is set to Low logic level and if the same PLC is receiving data at this speed then the RXDUBL pin is also set Low.

If the Bi-phase data rate is 11.28 MHz then PLC will generate a 22.56 MHz Clock in phase to the Master Clock from the Super Conan IC. In this case TXDUBL pin (9) of the PLC is set to High logic level and if the same PLC is receiving data at this speed then the RXDUBL pin (9) is also at logic level High.

The PLL lock range in this mode is around +/−25% and a diode clamp circuit is used to ensure the operation within this range. If the incoming data on the TXD is lost briefly then TXD will go either High or Low and PLL will free run at 45 MHz or 66 MHz and the transmitted signal will be rejected by the following receiver. Therefore for TXD=0 volts the RXD=5 Volts.

In this mode it is recommended that PLC starts from Power down after all valid voltage and signals levels settled hence minimising errors or receiver malfunctions.

This is the most preferred mode of the operation, as it only requires 2 connection between PLC and adjacent controller device within a node.

Mode 3, Crystal Oscillator: REFSEL=1, CLKSEL=0

This mode applies to the Master station in each of FIGS. 7 and 8. In this mode a crystal is used between pins XTI and XTO which is used by the PLL to lock and generate a synchronous clock signal at pin CLK. The clock output frequency will be the same or half of the crystal frequency, depending on the logic level setting on the TXDUBL Pin. The PLL in this mode has almost 100% lock range.

If TXDUBL=0 and XTAL=22.57 MHz then CLK=11.28 MHz (FIG. 7)

If TXDUBL=1 and XTAL=22.57 MHz then CLK=22.57 MHz (FIG. 8)

For double data rates the receiver side of the same PLC should have RXDUBL=1 for correct operation. This could be set permanently, or by a switch, or could be controlled by the local MCU if data speed is changing dynamically.

Note that the frequency setting resistor RFSET is assumed to be constant between FIGS. 7 and 8. That is to say, the change of frequency is controlled by the signals TXDUBL and RXDUBL alone. The same performance as FIG. 8 could be obtained by keeping TXDUBL and RXDUBL Low, but changing the frequency setting resistor appropriate to a clock frequency of 22.57 MHz (or whatever other frequency may be desired). The primary drawback to that approach is that the PLC is then committed to operate at the higher speed, unless the value of RFSET can be changed dynamically. By contrast, while RFSET remains constant, the PLC can be re-configured between the FIG. 7 and FIG. 8 situations by simply reprogramming the digital inputs TXDUBL and RXDUBL.

Mode 3 is preferred over Mode 1, although both are valid within the Master node. The reason for this is that, in Mode 1, the presence of external circuitry between the crystal reference and the PLC circuits can be expected to introduce timing variations (jitter). Jitter reduces the locking performance, noise margins and other performance parameters of the network, as would be expected by the skilled reader.

Further examples of the crystal frequency are given as follows:

A “double speed” D2B Optical network with a sampling frequency of 48 kHz:

Source data rate=16*8 bits*2 sub-frames*48 kHz=12.288 Mbps.

Crystal or external Clock frequency=24.576 MHz.

A “single speed” (CONAN®) D2B Optical network with a sampling frequency of 44.1 kHz:

Source data rate=16*8 bits*2 sub-frames*44.1 kHz=11.289 Mbps.

Crystal or external Clock frequency=22.578 MHz.

Point-to-point SPDIF communication with a sampling frequency of 44.1 kHz.

Source data rate=4*8 bits*2 sub-frames*44.1 kHz=2.8224 Mbps.

Crystal or external Clock frequency=5.6448 MHz.

Multi-Speed Network

FIG. 9 illustrates a synchronous ring network in which different segments are operating simultaneously at different data rates. The frame structures and other features of the Network Interface Controllers (NICs) which permit this apparently contradictory arrangement are explained in more detail in WO-A-98/36533, mentioned above. The present disclosure concerns only the additional complication of the PLC necessary to adapt those NIC devices for a UTP cable network.

In the example shown four stations or nodes 900-906 are connected in a ring. 900 is the Master station, and may for example be a display unit for control for the system, and having a Digital Versatile Disk (DVD) video playback facility. Station 900 has double and quadruple speed capability, necessary to accommodate the higher bandwidth of DVD products. Node 902, on the other hand, is a cheaper, or older product, incorporating only a single speed NIC, such as the CONAN® chip. Stations 904 and 906 are capable of operating at the higher rates. In this example, 906 is the DVD ROM drive which supplies DVD data streams for display by station 900.

To make optimum use of the capabilities of the different nodes, different network segments are operating at different data rates. From 900 to 902 and 902 to 904, the gross data rate is 5.64 Mbps, while from 904 to 906 and 906 to 900, the data rate is 11.28 Mbps. These modes can be pre-configured when the apparatus is installed, or negotiated by the devices among themselves. Each interface is labelled DS-SS, SS-SS etc., to indicate whether the receiving side and the transmitting side are configured at single speed (SS) or double speed (DS).

Table 2 illustrates the control signals applied to the PLC at each node 900 to 906 in the example of FIG. 9. By signals REFSEL and CLKSEL, node 900 is placed in Mode 3, with a crystal attached, suitable for its role as master. The crystal frequency is twice the DS data rate, at 22.56 MHz. RFSET is appropriate to single speed operation. With RXDUBL set to ‘1’, however, the receiving side of the PLC at node 900 is adjusted to respond to double speed signals. The PLCs at the other nodes 902 to 906 are in Mode 2, to recover their clock signals from the network. Nodes 902 and 904 have the same value of frequency-setting resistor RFSET, but with different settings of TXDUBL and RXDUBL as appropriate to their position between DS and SS segments.

TABLE 2
PLC Modes for FIG. 9

| NODE-RX-TX | MODE | XTAL | RFSET | TXDUBL | RXDUBL |
|---|---|---|---|---|---|
| 900-DS-SS | 3 | 22.56 MHz | 27 k | 0 | 1 |
| 902-SS-SS | 2 | — | 27 k | 0 | 0 |
| 904-SS-DS | 2 | — | 27 k | 1 | 0 |
| 906-DS-DS | 2 | — | 13.5 k | 0 | 0 |

OR . . .

| | | | | | |
|---|---|---|---|---|---|
| 906-DS-DS | 2 | — | 27 k | 1 | 1 |

For node 906, operating completely at double speed, two alternative configurations are possible, as the table shows. In the first alternative, resistor RFSET is set to half the value of the other nodes, causing the basic operating frequency of the PLC to be double that in the other nodes. TXDUBL and RXDUBL then are set to ‘0’. As an alternative, however, the same function can be obtained by keeping the resistor value the same as the other nodes, but causing both sides to operate at double speed by setting both TXDUBL and RXDUBL to ‘1’. The choice between these alternatives can be made, for example, on whether and how the designer wishes to change speeds, by software control of signals TXDUBL and RXDUBL.

Those skilled in the art will appreciate that other embodiments are possible, within the scope of the invention, and the specific embodiments described above are presented as illustrative examples only.

1. A physical layer interface for use in a local communication system for transmitting a digital data of at least 1.41 Mbps gross data rate interface comprising
means for receiving said digital data in the form of a binary waveform in which is encoded a serial data signal;
driver means for smoothing said binary waveform and imposing the smoothed waveform on a pair of conductors in the form of an analogue differential signal pair, and
decoder means adapted to receive and process a similar differential signal pair so as to recover a binary waveform in which is encoded a serial data signal from another station in the network.

2. A physical layer interface as claimed in claim 1 wherein the driver means includes means for reproducing said binary waveform with a slew rate regulated such that the reproduced waveform is substantially trapezoidal, such that each waveform transition occupies more than 30% of the minimum period between transitions.

3. A physical layer interface as claimed in claim 3 wherein each waveform transition occupies more than 60% of the minimum period between transitions.

4. A physical layer interface as claimed in claim 2 wherein each waveform transition occupies less than 90% of the minimum period between transitions.

5. A physical layer interface as claimed in claim 4 wherein each waveform transition occupies less than 80% of the minimum period between transitions.

6. A physical layer interface as claimed in claim 1 wherein the driver means includes means for adjusting said slew rate in proportion with the rate of data being transmitted.

7. A physical layer interface as claimed in claim 6 wherein the driver means is part of an integrated circuit, the adjustment means comprising a connection for an external resistor.

8. A physical layer interface as claimed in claim 7 further comprising a decoder for signals received from a similar physical layer interface, wherein in operation the same resistor controls other frequency-dependent parts of the integrated circuit, including a VCO centre frequency as part of a phase-locked loop and a time constant within a corresponding decoder.

9. A physical layer interface as claimed in claim 6 wherein the adjustment means is (additionally) controlled by a digital signal.

10. A physical layer interface as claimed in claim 6 wherein the means for adjusting the slew rate comprises at least one constant current source arranged to feed a capacitor under control of the PSK binary waveform, the current source current being adjusted according to the data rate.

11. A physical layer interface as claimed in claim 1, wherein frequency-dependent parts of the driver means and decoder are controlled separately, so as to permit different data rates at the driver and decoder.

12. A physical layer interface as claimed in claim 1 wherein the driver means comprises at least one constant current source and a capacitor to be charged intermittently from said current source under control of the PSK binary waveform.

13. A physical layer interface as claimed in claims 12 wherein the driver means comprises a complementary pair of constant current sources.

14. A physical layer interface as claimed in claim 12 wherein the current provided by the or each said constant current source is arranged to be adjusted according to the data rate.

15. A physical layer interface as claimed in claim 14 wherein the pair of current sources are is arranged to feed a single capacitor, the charge on the capacitor defining said smoothed waveform.

16. A physical layer interface as claimed in claim 12 wherein the driver means further comprises a transconductance amplifier for controlling the charging of said capacitor in response to the encoded binary waveform.

17. A physical layer interface as claimed in claim 1 further comprising a decoder for signals received from a similar physical layer interface and being adapted for use where said electrical conductors comprise a twisted pair cable, wherein said driver means comprises a differential line driver, and said decoder includes a differential input circuit for rejection of common mode noise.

18. A physical layer interface as claimed in claim 1 wherein the physical layer interface circuit further comprises a filter circuit for removing frequency components higher than the PSK carrier frequency, prior to imposing the encoded signal onto said conductors.

19. A physical layer interface as claimed in claim 18 wherein the filter has three or more poles.

20. A physical layer interface as claimed in claim 18 wherein the filter is implemented externally of an integrated circuit on which the remainder of the interface is located.

21. An apparatus for use as a first station in a local communication system, the apparatus comprising a phase shift keying (PSK) encoder and decoder for transmitting data to and from at least one other station via electrical conductors, each station including a similar encoder and decoder, the encoder comprising:
means for receiving said digital data in the form of a serial data signal together with at least one binary clock signal, the clock signal frequency being a small integer multiple of the data rate within the encoded serial data signal such that an integral number of cycles of the clock signal occur between transitions of the encoded serial data signal;
means for synchronising said serial data signal and said binary clock signal such that transitions in the one are aligned with transitions in the other;
an encoding logic circuit responsive to said digital serial data signal for selectively outputting one of said binary and the inverse thereof dependent on said serial data signal, so as to generate a binary waveform in which said serial data signal is PSK-encoded; and
driver means for smoothing said binary waveform and imposing the smoothed waveform on said conductors in the form of an analogue differential signal pair, the decoder of the apparatus being adapted to decode a similar smoothed waveform received from another station so as to recover an incoming digital serial data waveform.

22. An apparatus as claimed in claim 21 wherein the clock signal frequency may be regarded as the PSK carrier frequency, and is twice the highest frequency component contained within said encoded serial data signal.

23. An apparatus as claimed in claim 21 wherein the encoding of said digital serial data signal and the clock frequency is selected such that said integral number takes the value one or two, depending on the data content of the data signal, and disregarding any special synchronisation patterns present in the data signal.

24. An apparatus as claimed in claim 23 wherein the integral number takes a wider range of values than one or two.

25. An apparatus as claimed in claim 21 wherein the encoding logic circuit comprises an exclusive-OR gate.

26. An apparatus as claimed in claim 21 wherein said serial data signal is channel encoded so as to comprise either one or two transitions per data bit.

27. An apparatus as claimed in claim 21 wherein said serial data signals are encoded in differential form such that the recovered serial data signal is independent of inversion of the PSK encoded signal.

28. An apparatus as claimed in claim 21 wherein the synchronising means are combined with the generation of the encoded serial data signal.

29. An apparatus as claimed in claim 21 wherein the modem also comprises an encoder for generating said encoded digital serial data signal from a non-encoded data signal.

30. An apparatus as claimed in claim 21 wherein for operation where the encoder is located on a different integrated circuit from the source of the digital serial data signal, the synchronising means is a distinct circuit.

31. An apparatus as claimed in claim 21 wherein the carrier frequency of said PSK waveform is twice the gross data bit rate of said serial data signal.

32. An apparatus as claimed in claim 31 wherein the carrier frequency is 5 MHz or more.

33. An apparatus as claimed in claim 21 adapted for use where said electrical conductors comprise a twisted pair cable, wherein said driver means comprises a differential line driver, and said demodulator includes a differential input circuit for rejection of common mode noise.

34. An apparatus as claimed in claim 21 wherein the driver means includes means for adjusting the slew rate of the smoothed waveform in proportion with the rate of data being transmitted.

35. An apparatus as claimed in claim 21 wherein the encoder is part of an integrated circuit, the adjustment means including a connection for an external resistor.

36. An apparatus as claimed in claim 35 wherein the same resistor controls other frequency-dependent parts of the integrated circuit, including: a VCO centre frequency as part of a phase-locked loop; and a time constant within the decoder.

37. An apparatus as claimed in claim 21 wherein the adjustment means is (additionally) controlled by a digital signal.

38. An apparatus as claimed in claim 21 wherein the frequency-dependent parts of the encoder and decoder of at least one station are controlled separately, so as to permit different data rates at the receiver and encoder.

39. An apparatus as claimed in claim 21 wherein the driving means comprises at least one constant current source arranged to feed a capacitor under control of the PSK binary waveform.

40. An apparatus as claimed in claim 21 wherein the encoder further comprises a filter circuit for removing frequency components higher than the PSK carrier frequency, prior to imposing the encoded signal onto said conductors.

41. An apparatus as claimed in claim 40 wherein the filter is one of three or more poles, for example comprising a 5^{th} or 7^{th} order filter.

42. An apparatus as claimed in claim 40 wherein the filter is implemented externally of an integrated circuit on which the remainder of the encoder is located.

43. A non-coherent PSK decoder comprising an integrator circuit for integrating a received PSK encoded signal and a threshold comparator for converting the integrated signal into a digital data signal, the decoder including means for adapting the decoder to different PSK carrier frequencies by adjusting at least one of the integrator time constant and the comparator threshold.

44. A non-coherent PSK decoder as claimed in claim 43 wherein for where the decoder is part of an integrated circuit, the adjustment means including a connection for an external resistor.

45. A non-coherent PSK decoder as claimed in claim 44 wherein the same resistor controls other frequency-dependent parts of the integrated circuit, including: a VCO centre frequency as part of a phase-locked loop; an edge slope as part of an encoder for onward transmission of data.

46. A non-coherent PSK decoder as claimed in claim 44 wherein the integrator comprises at least one constant current source arranged to feed a capacitor under control of the received PSK signal, the current source current being adjusted according to the expected PSK carrier frequency.

47. A non-coherent PSK demodulator comprising an integrator circuit for integrating a received PSK encoded signal and a threshold comparator for converting the integrated signal into a digital data signal, the PSK demodulator comprising a comparator for converting the received PSK signal to a series of binary pulses prior to said integrator circuit, the integrator circuit and threshold comparator thus acting as a pulse width discriminator.

48. A non-coherent PSK demodulator comprising an integrator circuit for integrating a received PSK encoded signal and a threshold comparator for converting the integrated signal into a digital data signal, the integrator circuit comprising a separate integrator and threshold comparator for positive- and negative-going parts of the received PSK waveform, and a logic circuit or combining the outputs of the comparators to generate a decoded data signal.
